(19) United States
(12) Patent Application Publication
(10) Pub. No.: US 2004/0199605 A1
(43) Pub. Date: Oct. 7, 2004

(54) System and method of distributing customized content

(76) Inventors: Robert Z. LaCroix, Orlando, FL (US); Connie Culler, Orlando, FL (US)

Correspondence Address: GREENBERG TRAURIG LLP, 2450 COLORADO AVENUE, SUITE 400E, SANTA MONICA, CA, 90404, US

(21) Appl. No.: 10/819,532

(22) Filed: Apr. 6, 2004

Related U.S. Application Data
(60) Provisional application No. 60/320,095, filed on Apr. 7, 2003.

(51) Int. Cl. G06F 15/16

(52) U.S. Cl. 709/218; 715/501.1

(57) ABSTRACT

A customized content distribution system and method is disclosed herein. The customized content distribution system and method provides a software tool for partners to specify exactly what content they desire and delivers content directly to the partner based upon the specifications provided. In one aspect, the content comprises web based content such as digital data in the form of html code, text, graphics, or multimedia data.

### BACKGROUND

1. Field

This disclosure relates to new systems and methods for distributing content to business partners. More particularly, the disclosure relates to systems and methods for delivering customized web content to vendors and partners according to their individual specifications.

2. General Background and State of the Art

The Internet has recently been popularized by the overwhelming and rapid success of the World Wide Web (WWW or Web). The Web is rapidly evolving as a standard for distributing, finding, and accessing information of any type. The amazing growth rate in the demand for data over the Internet is partly due to an increasing audience. Another factor fueling the Internet growth is the exploding amount of information that is now available on the Web. The Web has grown from thousands of Web sites to a several million Web sites in a very short period of time. The growth continues at an exponential rate.

The web is a valued source of information and a very useful tool in assisting businesses to market their products. Businesses offer detailed information about their products and services on their websites. The day of requesting specialized marketing material from businesses and awaiting the arrival of printed brochures in the mail is gone, as the information can be readily available to anyone by simply visiting a specific website.

As more information is brought online, the demand to categorize, search, personalize, and retrieve the information is placing new demands on businesses.

Large companies or businesses that offer many different products and services often work with other vendors or business partners to further market and sell these products and services. For example, the Wait Disney company offers a wide array of services. They are most well known for their theme parks, hotels, and cruises. Such a company may work with third parties such as travel agents, wholesalers, etc. who work to sell their vacation packages. In order for these third parties to effectively sell their product, they must not only have detailed information about the various products, but they must have advertising material to show to their customers.

A significant problem facing the continued growth of Internet marketing is that methods for distributing content to business partners web sites are not well established.

### SUMMARY

A customized content distribution system and method is disclosed herein. The customized content distribution system and method provides a software tool whereby a partner of a business or organization can specify exactly what content they desire and delivers content directly to the partner based upon the specifications provided. In one aspect, the content comprises web based content such as digital data in the form of HTML code, text, graphics, or multimedia data. The customized content distribution system and method accomplishes this while also electronically maintaining control of the content distributed.

The term “partner” as used herein refers to anyone who sells a product or service for the “business”. For example, a partner can be a wholesaler or retailer which specializes in selling products offered by the business they partner with. The business may for example be a manufacturer of a product. In an embodiment as described herein, the business offers a service or attraction such as a theme park, travel destination, hotel, or resort.

In one aspect, a method of distributing customized content comprises providing a web page including embedded code configured to send a request for customized content to a server over a computer network. For example, the web page provides various selection inputs through use of a form, for specifying parameters relating to the content. Parameters may include, for example, the type of content desired, or the page layout of the content generated. A server receives the request for customized content including the parameters specified by the partner. Content is selected from a content database based upon the selections made, and code is generated which represents a web page comprising the selected content.

A code string, or a URL is transmitted to the user. The URL can be used for incorporation into a web site.

Alternatively, the customized content distribution system and method may comprise a standalone software application that runs on the partner's computer. The software application could be distributed to the partner by downloading from a web site or remote server. Alternatively, the software application could be distributed by mailing a CD-ROM, floppy disk, or other type of computer media to the partner.

The customized content distribution system and method provides content to partners according to their unique needs and specifications. The content may be created and ready for immediate display on their consumer facing web site, i.e. fully designed web pages with content designed for consumers, or to agent facing web sites, i.e. fully designed web pages with content designed for agents only.

The content can also be individual content elements that a partner selects and adds to their web sites within their own design. For example, bits and pieces of content such as graphics, text, etc. may also be provided for the partner.

For the partner, it is quite convenient because there is no need for a web designer to create a new website from scratch. The content selection application disclosed packages all the content necessary for a web page/site and creates the source code also. The user does not need to know anything about creating web pages.

The customized content distribution system and method allows for providing content to partners according to their specifications, however in a manner that enables content to be electronically controlled from a provider source. The provider receives valuable marketing on the web and additional sales through the partner. The information is also guaranteed to be more consistent if it is all coming from the same place. The process is also time efficient.

The customized content distribution system and method can be used for distribution of customized content other than web pages. The customized content distribution system and method can be easily adapted to deliver customized content for use in print publications. The partner simply receives the content in electronic format, and is then able to print it as necessary.

The foregoing and other objects, features, and advantages of the present disclosure will be become apparent from a reading of the following detailed description of exemplary embodiments thereof, which illustrate the features and advantages of the invention in conjunction with references to the accompanying drawing Figures.

### DRAWINGS

FIGS. 1a-b illustrate flow diagrams of one embodiment of a customized content distribution system and method.

FIG. 2 illustrates an example of menu selections.

FIG. 3 illustrates a block diagram of an exemplary system.

FIGS. 4-7 are screen shots of an exemplary web based content selection application.

FIG. 8 is a screen shot illustrating an exemplary web page as created by the content selection application.

FIGS. 9-9c are screen shots illustrating how a link to the content created by the content selection application is easily incorporated into an existing web site.

### DESCRIPTION

In the following description of exemplary embodiments reference is made to the accompanying drawings which form a part thereof, and in which are shown by way of illustration specific embodiments which may be practiced. It is to be understood that other embodiments may be utilized and structural and functional changes may be made without departing from the scope of the present disclosure.

The disclosure provides a customized content distribution system and method whereby a business or other organization provides their partners access to an application whereby the partner can select content relating to products and/or services offered by the business according to the partner's own specifications and unique needs. In one aspect, the content is descriptive or informative content relating to products or services offered by the business. For example, the content may include marketing material such a descriptive text, photos, or video. In-one embodiment, the content may be in electronic format such as JPEG images, HTML code, text documents, etc. Alternatively, the content may be in hard copy format such as customized brochures, flyers, or other printed materials.

A content selection application is provided whereby a partner may select the specific type and/or format of content desired. In one embodiment, the application is a web based application which can be accessed by entering a specific URL into a web browser. The web based content selection application provides a plurality of selections whereby the partner can specify what type of content is desired.

In one aspect, the partner uses a computer to access a web page that may include embedded code configured to send the request for customized content to a server over a computer network. The server retrieves content corresponding to the specifications input by the partner on the accessed web page from a database. The server then applies the specifications to a rule base or template to create resultant code. The corresponding content to be posted in the resultant Web page is also selected from a content database.

In one embodiment, the content is packaged and the resultant code and corresponding content is electronically transmitted to the partner. In another embodiment, the partner is sent only a URL to the content. Content includes, for example, but is not limited to, html code, text, graphics, images/photographs, video clips/movies, 360° views, etc.

The infrastructure of such a system is generally a computer network which enables each component of the system to communicate to find, define, customize, and deliver content for the consumer. In one embodiment, the computer network is the global Internet computer network, which uses common communication protocols such as Transmission Control Protocol/Internet Protocol (TCP/IP) to exchange data between machines.

Together the integrated components of this system enable web browsers to display the system's user interface applications to users at remote locations, from anywhere on the computer network, using TCP/IP to exchange data.

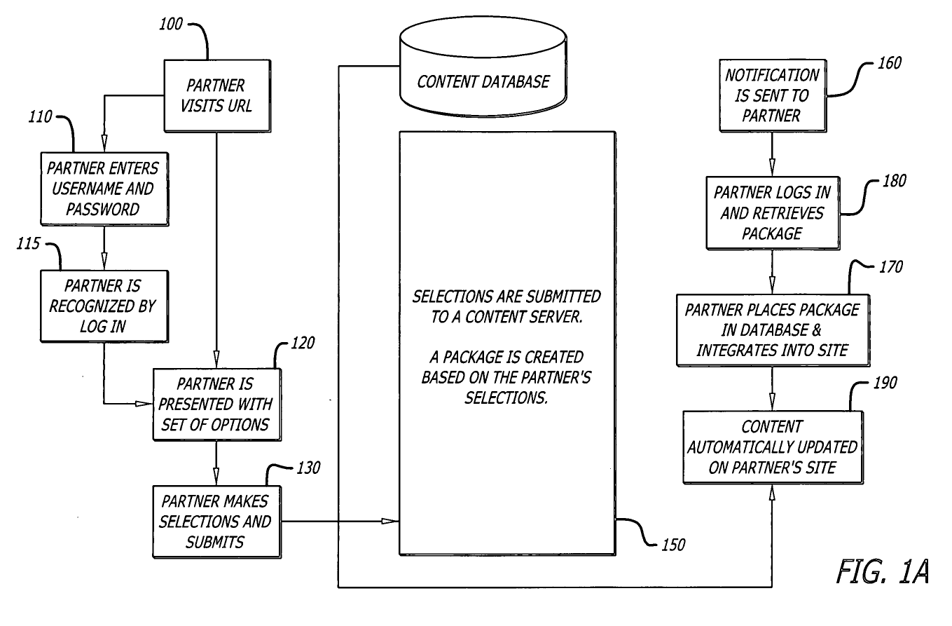

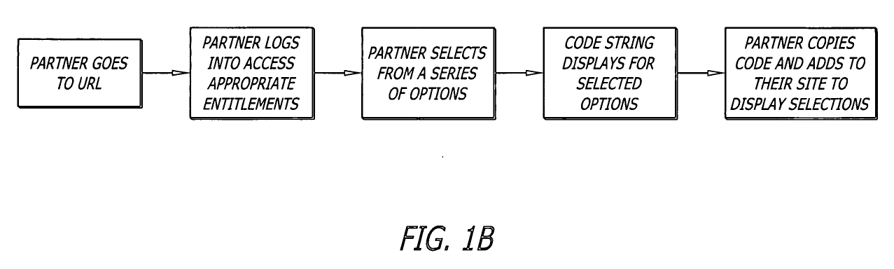

FIG. 1 illustrates a block flow diagram of an exemplary embodiment of a system and method of content distribution. In one instance, a business partner visits a particular website by using a URL as instructed or provided by the business or content provider, as is indicated at block 100. In an exemplary embodiment, the URL may be customized for each partner, thereby providing a more user friendly process for the partner. Furthermore, this provides an easily recognizable and easy to remember URL that encourages use.

The partner may be prompted for login information, such as a username and password, as is indicated at blocks 110 and 115. If this is the case, appropriate access must be granted to the partner prior to use of the system.

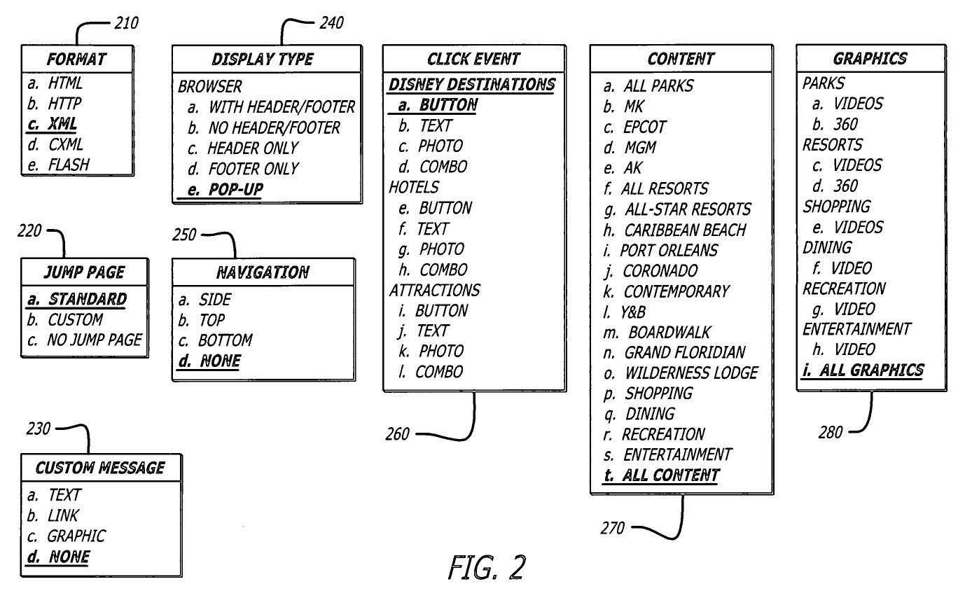

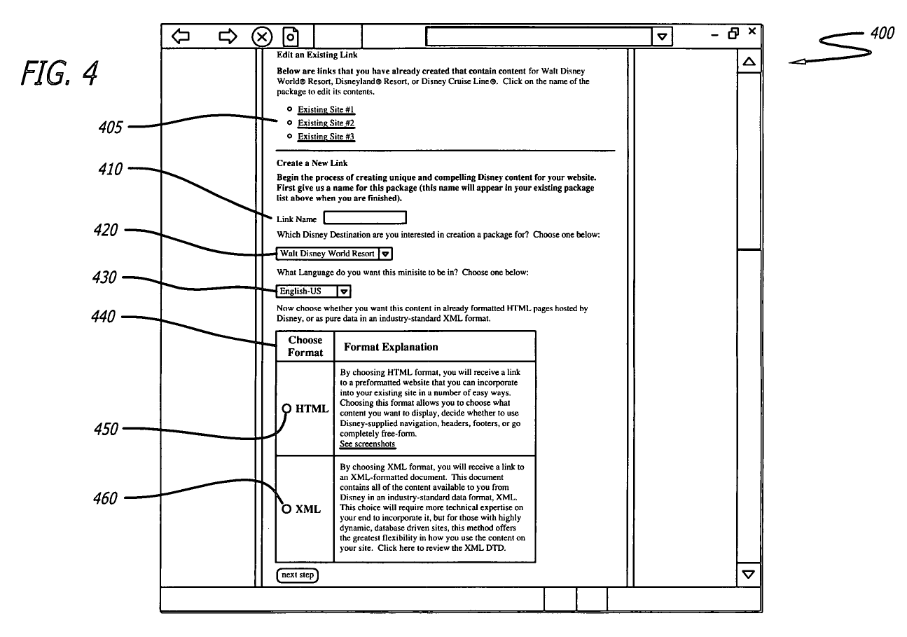

Upon successful login to the system, the partner is provided with a set of options, as is indicated at block 120. In one aspect, a partner chooses from options as presented on a fill-in form. Options may be presented as drop down menus, check boxes, radio buttons, or other commonly known user input or selection means. The fill-in form is currently presented in HTML, but can be implemented using alternative web technologies such as Flash or Java. For example, an exemplary series of menu choices are illustrated in FIG. 2. Screen shots from yet another exemplary embodiment are shown in FIGS. 4-7.

The partner enters his or her desired selections for content as is indicated at block 120. Upon selection of all the desired parameters, the partner's specifications are transmitted to a server 150 for processing. The server 150 creates a content package based on the partner's specifications. The content package consists of the source code that defines the web page or pages, and the supporting content specified by the source code. Supporting content includes, for example, text, images, photos, videos, maps, logos, icons or other digital media. With respect to descriptive text, there also may be different levels of description, from a general overview to in depth details, including for example, pricing and disclaimers.

The content package is created by using templates that are previously created by the content provider. The templates define the structure of a web page. In one embodiment, code is dynamically generated from a template, which will provide a the framework for a web page. A dynamic template is created using a number of variables which relate to the parameters chosen by the partner. Each of the variables are filled in to the template, creating a unique web page.

Notification is then sent to the partner that the content package has been created, as indicated at block 160. Generally notification further includes instructions for how to use the content package.

This may be accomplished in a number of ways. In one embodiment, notification may be in the form of a confirmation page which is displayed after the partner has made their content selections. In one embodiment, a code string is returned to the partner. The code string may be a URL where the resulting web page or pages can be viewed. The partner can then copy the code string to their site to display the desired page. The partner can alternatively visit the URL and copy the source code and graphics from this URL and insert the code and corresponding content into their site.

Other options for transmitting the content package include saving the data to a directory where the partner can download, perhaps via ftp, the files and enter them to their website. The content package could also be sent as an attachment via email to the partner. The files could also be saved on removable media such as a CD-ROM, disk, or DVD-ROM and mailed to the partner.

An exemplary menu selection system in accordance with a content distribution system and method is illustrated in FIG. 2. The menus shown in FIG. 2 offer the partner the opportunity to select from a number of options by which to define the content and/or format required for their web page. Exemplary selections are highlighted in bold. The format of the overall page can be selected. For example, in menu 210, options are provided for, but are not limited to HTML, XML, CXML, or Flash sites.

An option for whether or not the partner would like to include a Jump page is shown at 220. An option for whether or not a custom message should appear is shown at 230.

The partner may also choose what type of display layout they prefer. For example, in menu 240, the partner may choose to return a page with a header and footer, header only, footer, or no header or footer. Similarly, the partner may choose to have a page with side, top, or bottom navigation bars, as is indicated at menu 250.

The partner may also define how links are displayed on their page. This is shown in menu 260, where “click events” are defined. For example, the partner may choose from displaying links as a button, text, photo, or a combination of these items. The click event may differ for various sections of the site, or depending on the particular content.

In menu 270, the partner selects what content they would like. Perhaps the partner is a travel agent, and only interested in content related to travel. Or perhaps, more specifically, the partner is a travel agent which only deals with travel to a certain region. The partner can choose as much or as little content as they would like.

In box 280, the partner chooses the form or type of content they would like. For example, the partner may just want a simple site consisting of text and graphics. Or the partner may desire to include videos as well. Content types may be specified for all content categories, or for particular content categories.

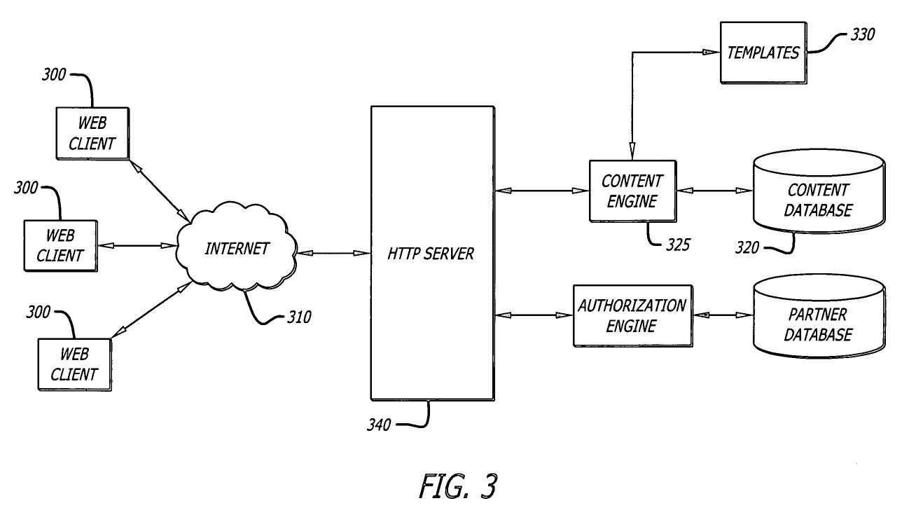

FIG. 3 is a representation of the system architecture of the content distribution system and method. In FIG. 3 a number of web clients 300 are connected to the Internet 310. Web clients 300 may be located at any number of remote locations through which users, such as partners connect to a computer network. Web clients 300 interact with a computer network such as the Internet 310 through a series of user interface applications. Web clients 300 may include computer terminals at a variety of locations which are capable of accessing the user interface applications.

The system also includes a content database 320 coupled to a customized content engine 325. The content database 320 includes all the content necessary for creating a web page, including template information 330 which defines how the content is arranged or presented on the web site.

The client (such as web client) 300 is a machine on the computer network running web browser software such as for example Netscape Navigator or Microsoft Internet Explorer. This web browser can be running on any hardware/operating system platform capable of communicating using the Hypertext Transport Protocol (HTTP) over TCP/IP, rendering information sent by the system in Hypertext Markup Language (HTML) and capable of running script written in the JavaScript language and applications or applets written in the Java programming language.

The clients 300 will communicate over a computer network such as the Internet 310 by using an HTTP Server 340. HTTP server 340 is responsible for serving the above-mentioned text, script, and programs to the many clients 300 that are simultaneously connected to the system. The server functionality can be achieved using an existing HTTP server product, such as Microsoft Internet Information Server, Netscape Server, or Apache. Several “engines” manage the integration between the server and the rest of the system. These engines can be implemented using one or more commonly accepted HTTP server integration technologies, such as Common Gateway Interface (CGI), Java servlets, Active Server Pages (ASPs), Internet Server Application Programmer Interface (ISAPI) and Netscape Server Application Programmer Interface (NSAPI).

The content engine 325 provides the means by which a partner specifies preferred content. Content engine 325 identifies and retrieves content from the online content database 320. The content database (or databases) 320 holds all of the system's content and attributes of the content. Effectively, the content database 320 is a vast inventory marketing materials, maintaining potentially terabytes or petabytes of assets.

FIGS. 4-7 are screen shots illustrating an exemplary embodiment of the content selection application. FIG. 4 illustrates an exemplary first screen 400 of the web based content selection application. In this example, the content selection application provides web content related to Walt Disney Resort, Disney Cruise Line, and the Disneyland Resort. Partners such as travel agents can use the content selection application to create customized content for their own websites. The content selection application provides instruction on how to easily add the content to a website. Furthermore, in an exemplary embodiment, the partner is able to manage and update the content they receive automatically by using the content selection application.

In an exemplary embodiment, the content selection application begins with providing a user the option to edit an already existing link or to create a new one. The first time using the content selection application, there will not be any existing links to edit. However, after going through the content selection application at least once to set up a link, returning to this screen will display the links previously created. Existing links 405 to content packages previously created are shown towards to top of screen 400. Clicking on a link 405 allows a partner to view or edit the existing content package.

Alternatively, to begin the process of creating unique and compelling content for a website, the content selection application prompts the user to provide a name for the content package being created as shown at text entry box 410. This is the name that will appear in the list of existing links to packages as described above. A “package” is for example a set of complete HTML pages. The user can customize each package to contain the pages the user would like to use.

Next, the user selects from a drop-down list 420 the type or category of content desired for the new package. For example, in this example, the user may select to create a content package for Walt Disney World, Disneyland Resort, or Disney Cruise Lines. Depending on the application or nature of the business and partner relationship, the contents of such a drop down list may differ. For example, if the business were a manufacturer, the drop down list might contain a list of the manufacturer's various product lines or categories.

The content selection application may further provide the option to generate content in a plurality of different languages. Drop down list 430 indicates that the partner has selected to generate content in English.

The format of the website can chosen as indicated by drop down list 440. In the exemplary embodiment shown, a user can select that the custom website be created using HTML code 450 or XML code 460. Other embodiments may provide many different options for the formatting of a website.

For example, by choosing HTML format, the partner will receive a link to a preformatted website that the partner can incorporate into an existing site in a number of easy ways. Choosing this format allows the partner to choose what content to display, whether to use Disney-supplied navigation, headers, footers, or go completely free-form.

By choosing XML format, the partner will receive a link to an XML-formatted document. This document contains all of the content available to the partner from the provider in an industry-standard data format, XML. This choice may require more technical expertise to incorporate it, but for those with highly dynamic, database driven sites, this method offers the greatest flexibility in how to use the content on an existing site.

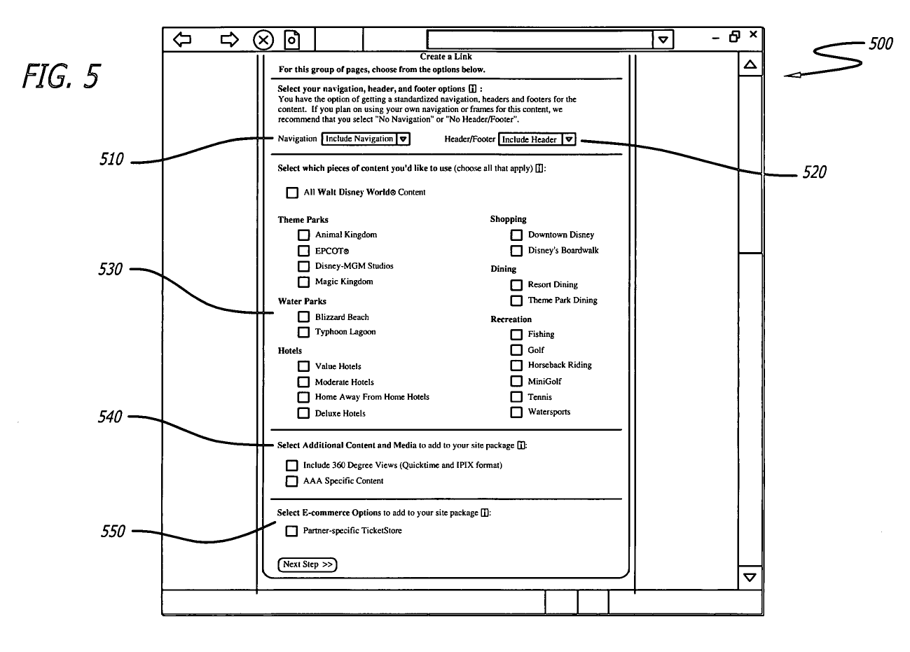

A next screen of an exemplary embodiment of the content selection application is illustrated in FIG. 5. Further options for specifying content are provided in screen 500. For example, the user may choose whether or not navigation should be included with each package 510. Furthermore, the user may choose whether or not a header or footer should be included 520.

Next, the user selects what pieces of content should be included in the package. In this embodiment, the options provided as indicated at 530 are dependent on the category selection made from the drop down list 420 of the first screen 400. In the current example, since content in the category “Walt Disney World Resort” was chosen, more specific options related only to “Walt Disney World Resort” are shown in screen 500. More specific pieces of content can be selected by selecting or unselecting checkboxes.

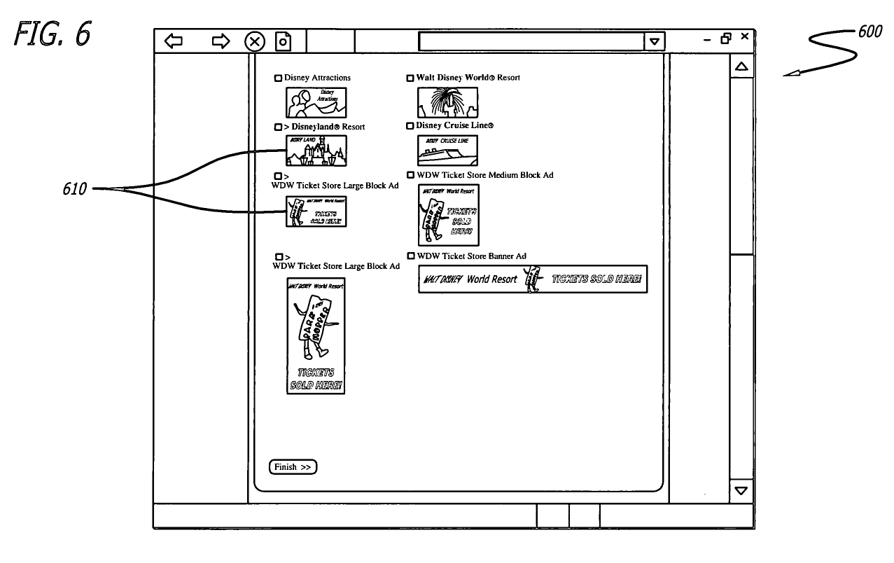

FIG. 6 illustrates a next screen 600 in an exemplary embodiment of the content selection application. In this screen 600, options are provided to the user in the form of buttons or graphics 610, which will provide the link to the newly created content package. In the example shown, the user may select from graphics 610 in accordance with different types of content. Alternatively, the user is not required to select a graphic. When the user is done making selections, the “finish” button in clicked, and a confirmation screen is displayed.

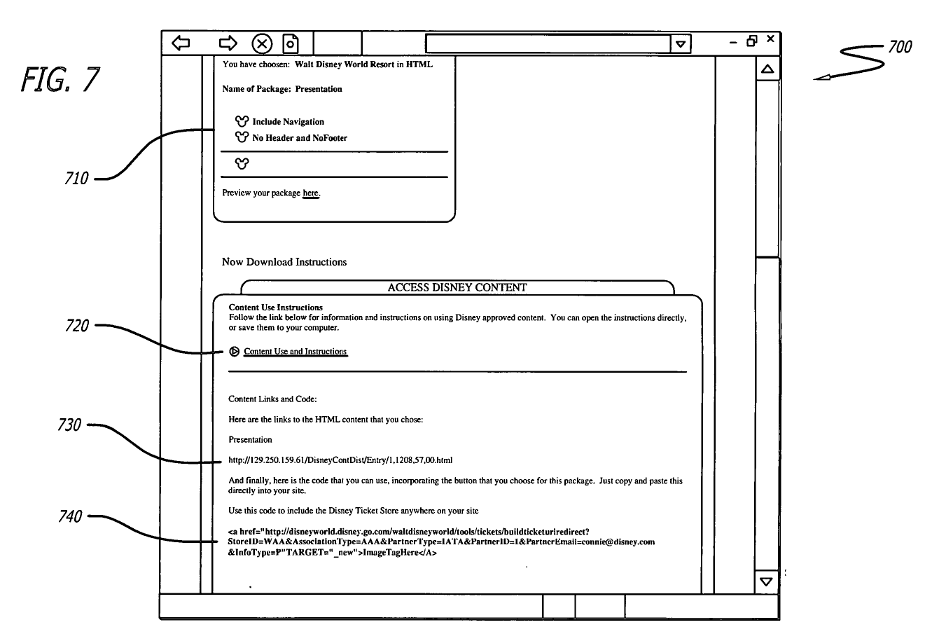

A screen shot of an exemplary confirmation page for the link or package just set up using the content selection application is displayed in FIG. 7. A summary 710 of the selections made in the previous screens of the content selection application, as shown in FIGS. 4-6, is now displayed. In this example, the confirmation page shows that the user has selected to create a page in HTML, including navigation and a header and footer. A button or link to preview the package created is also provided.

The confirmation page also provides instructions 720 for incorporating the content package into the user's website.

In an exemplary embodiment, the content package is provided to the user as a URL, or web link 730. The URL 730 is simply placed within a user's website, and can be accessed by clicking on a link or graphic to that URL. In one aspect, the content package is managed at a remote location. In another aspect, the content package is created at a remote location, and sent to the user for management at their own location.

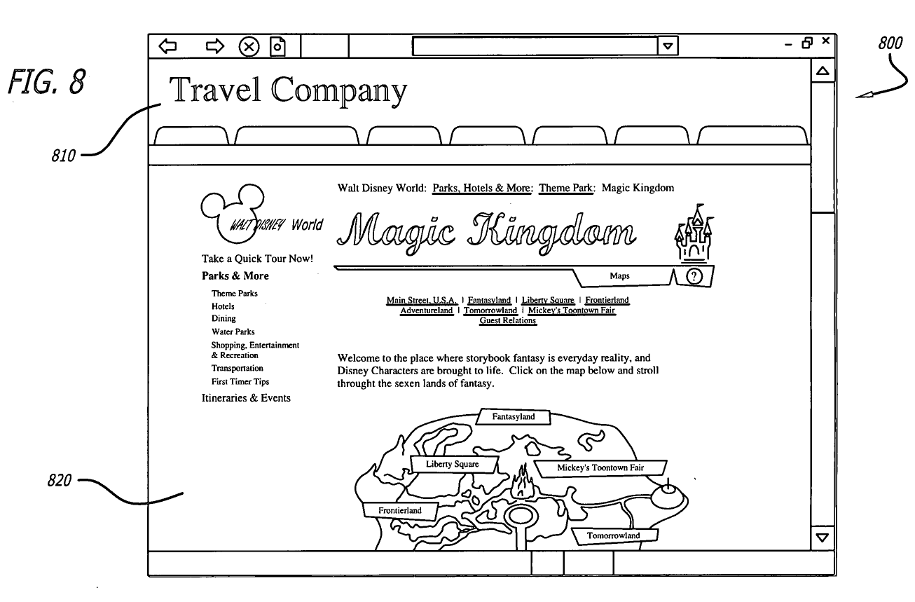

FIG. 8 is an example of the web package created by the content selection application. Screen 800 is meant to illustrate how the customized content is incorporated into an existing website. In this example, the partner is a travel company, having an existing website as indicated at 810. In this case, the Travel Company has utilized a “tab” layout for their website. The customized content as created by the content selection application is shown within one of their “tabs” as indicated at 820.

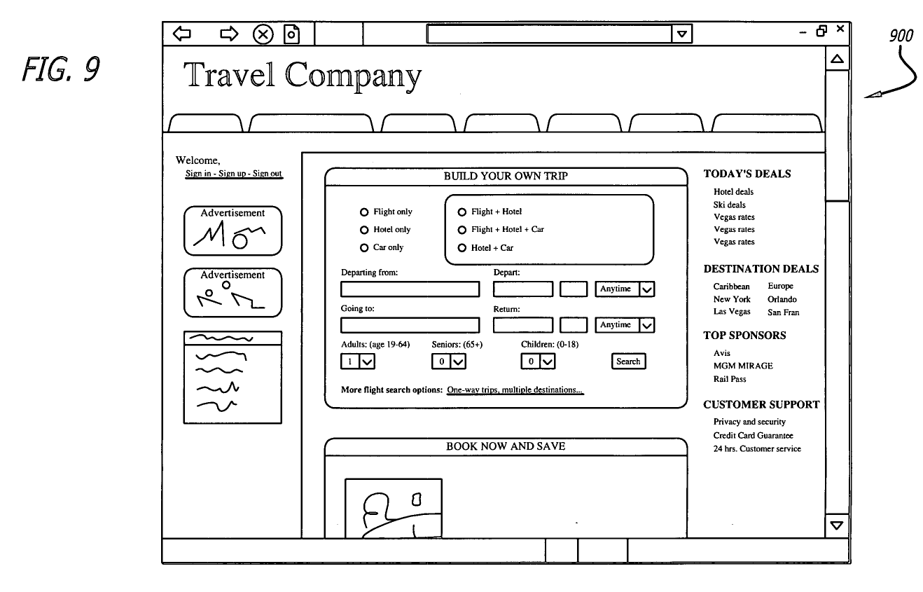

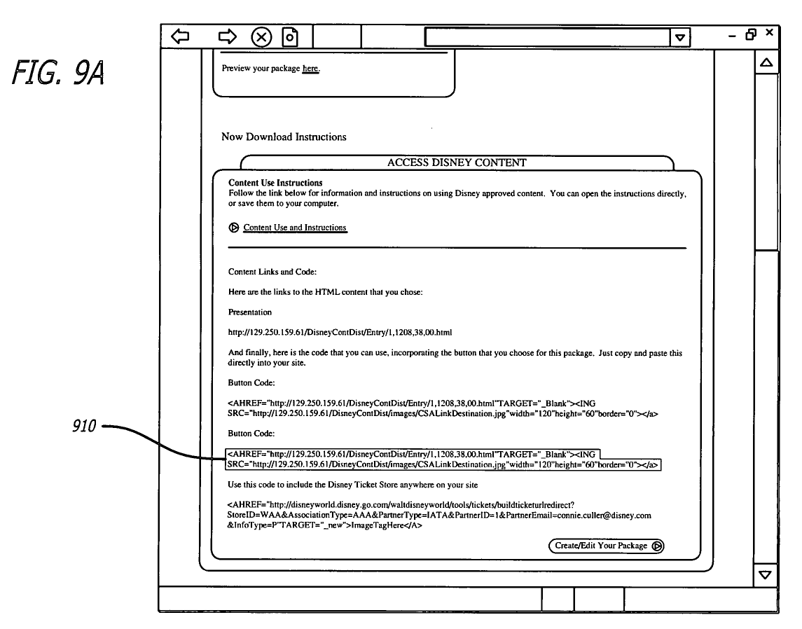

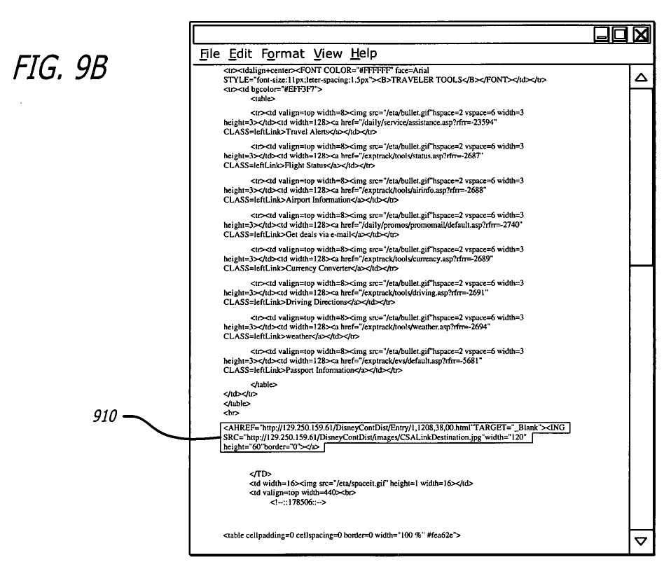

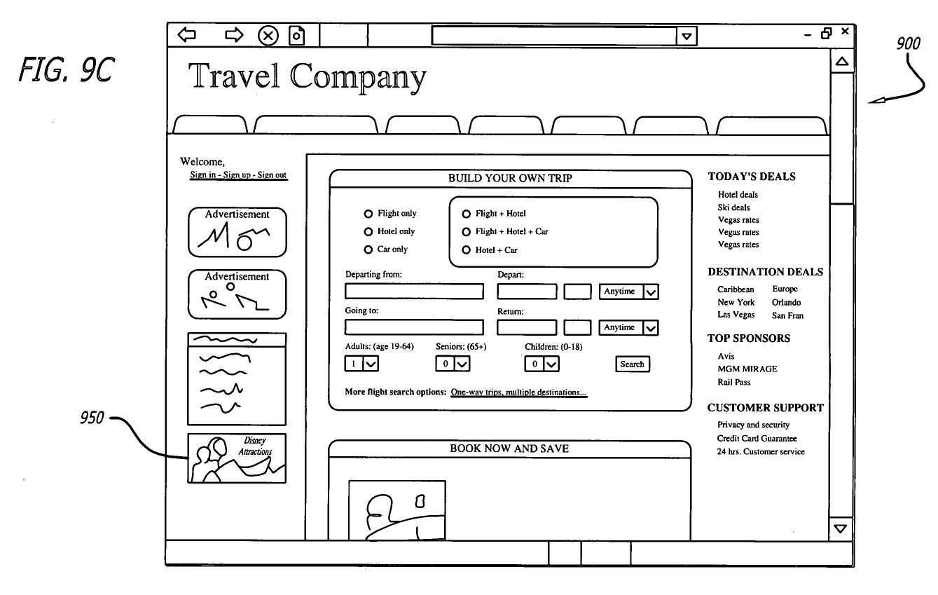

FIGS. 9a-e show how the content package is easily incorporated into an existing website. For example, a web site for an Internet travel wholesaler (“Travel Company”) is shown. The “Travel Company”, creates a content package using the content selection application disclosed herein. As was illustrated in FIG. 7, the content selection application may return a URL 730 of the location where the content package resides. The custom web site may then be incorporated into the partner's existing web site by including the URL 730 as returned by the content selection application. Furthermore, in one embodiment, the content selection application provides the proper HTML code 740 for incorporating the new content into a partner's web site.

FIG. 9a shows a portion of an exemplary confirmation page as returned by the content selection application. The confirmation page returns the URL, as well as “button code” 910 for directly cutting and pasting into a web site. The highlighted portion of text 910 shown in FIG. 9a is an example of the html code that is inserted into a partner's site in order to incorporate the new content. FIG. 9b shows the same highlighted portion of HTML code 910 as it has been inserted into the source code of an already existing web site. FIG. 9c shows the result of inserting the code. An icon or graphic 950 linking to the new content is now displayed in the lower left portion of the page.

The customized content distribution system and method can be used for delivering web based content in many types of business-partner relationships. The customized content distribution system and method has applications in almost any market. Travel and vacation information is just one example of the many applications for the present disclosure. The customized content distribution system and method can be used for relationships between manufacturers of goods, and the businesses that sell their goods. For example, an automobile manufacturer could provide this service to its auto dealerships with individual websites. A furniture manufacturer could utilize the content selection application to distribute sales information to those retail locations or other distributor that offer their furniture for sale. The content selection application can also be used to distribute customized sales and marketing information in just about any provider-seller relationship, in a time effective manner.

The system and method of customized content distribution could also be utilized within businesses. For example, a business could easily customize marketing materials for presentation to a client by using a content selection application as described in the present disclosure. In this case, the application could be a local application and not need to be a web application allowing remote access.

The system and method of customized content distribution can also be used for distribution of customized content other than web pages. The system described in the disclosure can be easily adapted to deliver customized content for use in print publications. The partner simply receives the content in electronic format, and is then able to print the material accordingly. In this embodiment, print brochures, posters, flyers, business cards could all be designed by the partner and printed for their own use.

The content selection application allows partners to completely customize content according to their desires. As mentioned above, the content may include marketing material such a descriptive text, photos, or video. Furthermore, the partner may choose from formatting options such as HTML vs. XML code, whether or not to include navigation, etc. However, the full scope of options that could be made available by the content selection application disclosed herein is limitless. Formatting options such as colors, fonts, backgrounds, image quality, etc could be offered. In general the options by which content can be selected and generated should not be limited by the present disclosure.

The system and method of customized content distribution provides Internet content to partners that is complete, relevant, timely, accurate, and useful so that they can sell more products and services to more people more efficiently and effectively. The content includes, at a minimum, supporting material that is necessary to sell products or services offered by a business, and is preferably provided subject to copyright guidelines.

The foregoing description of the preferred embodiments of the invention has been presented for the purposes of illustration and description. It is not intended to be exhaustive or to limit the invention to the precise form disclosed. Many modifications and variations are possible in light of the above teaching. For example, the various activities and supplemental features described herein may be stored and provided to users on storage media other than DVDs. The read along activity and product may also be supplemented by features and supplemental content other than those described herein. It is intended that the scope of the invention be limited not by this detailed description, but rather by the claims appended hereto.

What is claimed is:

1. A method of distributing customized content, comprising:
maintaining a database comprising electronic content;
providing a web interface comprising a plurality of selection means for defining a content package;
creating a customized content package based on the selections made through the web interface;
generating code representing a web page to display the selected content;
storing the code on a server connectable through a computer network; and
electronically transmitting a URL comprising the location of the code to the merchant.

2. The method of claim 1 wherein the content relates to a product or service offered by a business and is used by partners of the business to aid in marketing the product or service.

3. A method of distributing customized content, comprising:
maintaining a database comprising electronic content;
providing a web interface comprising a plurality of selection means for defining a content package;
selecting content from the database based on the selections made through the web interface;
creating a content package; and
electronically transmitting the content package to the merchant.

4. The method of claim 3 wherein the content relates to a product or service offered by a business and is used by partners of the business to aid in marketing the product or service.

5. The method of claim 3 wherein further comprising generating code representing a web page to display the selected content.

6. A method of distributing customized content, comprising:
providing a web page configured to send a request for customized content to a server over a computer network, the web page providing a selection system for specifying parameters defining the customized content;
receiving a request for customized content from the partner including the parameters specified by the partner;
selecting content from a database based upon the parameters specified by the partner,
generating code representing a web page including the selected content;
packaging the code and the corresponding selected content into a content package; and
transmitting the content package to the accessing partner for posting into a Web site.

7. The method of claim 6 wherein the parameters include page layout and type of content.

8. The method of claim 6 wherein the step of generating code representing a web page is done dynamically by utilizing a template that defines the structure of a web page.

9. The method of claim 6 wherein the step of transmitting includes sending the partner an email with a link to the location of their content package.

10. The method of claim 9 further comprising the step of saving the content package on the server and allowing the partner access to and downloading of the content package.

11. The method of claim 6 wherein the step of transmitting includes emailing the content package to the partner.

12. The method of claim 6 wherein the step of transmitting the content package is by saving the content package onto a CD-ROM and mailing the CD-ROM to the client.

13. The method of claim 6 wherein the step of transmitting the content package comprises displaying a URL.

14. The method of claim 6 wherein the URL is inserted into the partner's website.

15. A method of distributing product and/or service information to at least one of a plurality of sellers/merchants of the product and or service, the method comprising:
maintaining a database comprising content used to describe at least one product or service;
providing a plurality of variables/preferences for a merchant to specify;
creating a content package based on the merchant preferences; and
electronically transmitting the content package to the merchant.
